(19) United States
(12) Patent Application Publication
(10) Pub. No.: US 2024/0405587 A1
(43) Pub. Date: Dec. 5, 2024

(54) MANAGING IMPACTS OF BATTERY CHARGING ON DATA PROCESSING SYSTEMS

(71) Applicant: Dell Products L.P., Round Rock, TX (US)

(72) Inventors: GERONCIO ONG TAN, Austin, TX (US); MERLE JACKSON WOOD, III, Round Rock, TX (US); MARCIN M. NOWAK, Round Rock, TX (US); WEI-CHENG YU, New Taipei City (TW); CHIN JUI LIU, Luzhu City (TW)

(21) Appl. No.: 18/327,652

(22) Filed: Jun. 1, 2023

(51) Int. Cl. H02J 7/00

(52) U.S. Cl. CPC H02J 7/007182; H02J 7/0048

(57) ABSTRACT

Methods and systems for managing battery charging are disclosed. To manage battery charging, a data processing system may dynamically configure the operation of power adapters and chargers used to charge the battery. Dynamically configuring the operation of these devices may improve the efficiency of the charging thereby reducing power dissipation for charging the battery. Additionally, dynamically configuring the operation of these devices may also reduce the likelihood of brownout or other undesired impacts.

### FIELD

Embodiments disclosed herein relate generally to device management. More particularly, embodiments disclosed herein relate to systems and methods for management of battery charging for devices.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2 shows a data flow diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing battery charging. To manage battery charging, a data processing system may dynamically configure the operation of power adapters and chargers used to charge the battery. Dynamically configuring the operation of these devices may improve the efficiency of the charging thereby reducing power dissipation for charging the battery.

The components may be dynamically configured based on the power state of the data processing system, the power consumption rate of the data processing system, and the ability of the power adapter and the battery to supply power. By dynamically configuring the power adapter and charger, the likelihood that brownouts or other undesirable outcomes may be reduced.

Thus, embodiments disclosed herein may provide a data processing system that facilitates battery charging while managing undesired outcomes. By reducing power dissipation during charging, thermal dissipation capabilities of the data processing system may be preferentially used to dissipate heat from hardware components that directly provide computer implemented services rather than for dissipating heat generated during battery charging. Consequently, the computer implemented services provided by the data processing system may complete tasks more quickly by virtue of the ability of the hardware components to consume more power in their operation due to the larger quantity of heat that may be dissipated from them.

Therefore, embodiments disclosed herein may address, among others, the technical problem of thermal management in data processing systems that utilize batteries. By reducing thermal generation by components of data processing systems that do not directly contribute to computer implemented services (e.g., but that contribute to battery charging), the quality of the computer implemented as perceived by users of the data processing systems. For example, the hardware components of the data processing system that do contribute directly the computer implemented services may be able to operate more quickly thereby generating more heat but being able to have that heat dissipated by virtue of the reduced heat generation for battery charging.

In an embodiment, a method for managing charging of a battery of a data processing system is provided. The method may include, while the battery is at least partially discharged: identifying a first voltage level of the battery; obtaining a scaling margin based, at least in part, on the first voltage level and a power state of the data processing system; configuring a power adapter to supply first power at a second voltage level to a charger of the data processing system to obtain a configured power adapter, the second voltage level being based on the first voltage level and the scaling margin; configuring the charger to supply second power at a third voltage level to the battery to obtain a configured charger, the charger providing the second power using the first power; and charging the battery using the configured power adapter and the configured charger.

The configuring of the power adapter and the configuring of the charger may be performed repeatedly at predefined time intervals to update the second voltage level and the third voltage level over time while the battery is at least partially discharged.

The power adapter may have a loop response for updating the second voltage that is slower than the predefined time intervals.

The data processing system may include at least one hardware component that places transient loads on the adapter that exceed a capacity of the loop response to maintain the second voltage.

Obtaining the scaling margin may include in a first instance of the power state being a dynamic power consumption state: identifying power consumption by the data processing system; and identifying the scaling margin based, at least in part, on the power consumption that is likely to retain the charger in buck mode rather than boost mode.

The scaling margin may be further based on a battery maximum peak power at a current relative state of charge of the battery, and a peak power capability of the power adapter.

Obtaining the scaling margin may include in a second instance of the power state being a static power consumption state: setting the scaling margin to zero.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor. The non-transitory media and the processor may be part of a management controller of the data processing system.

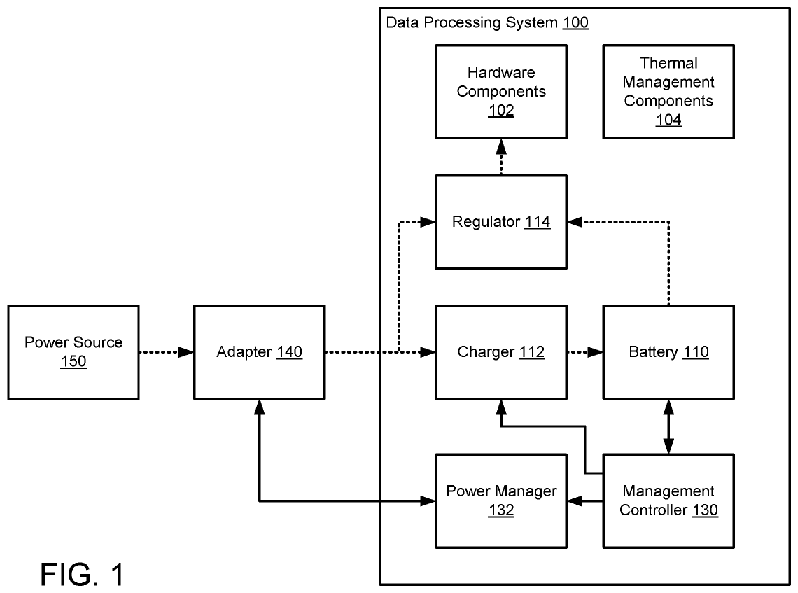

Turning to FIG. 1, a block diagram illustrating a system in accordance with an embodiment is shown. In FIG. 1, rectangular blocks represent devices and components of devices. A select number of power flows between the components are illustrated using dashed lines terminating in arrows. The direction of the arrow indicates the direction of power flow. Additionally, a select number of communication channels are illustrated using solid lines terminating in arrows. However, it will be appreciated that these selections are shown to clarify certain aspects of the disclosure, but that additional, different, and/or fewer power flows and communication channels may be present without departing from embodiments disclosed herein.

The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, the system may include data processing system 100. Data processing system 100 may include any number of hardware components 102 that provide the computer implemented services. For example, hardware components 102 may include processors, memory modules, storage devices, communication devices, and/or other types of devices. These hardware components 102 may host software applications that provide the computer implemented services.

To operate, hardware components 102 may consume power and generate heat. The power may be provided by battery 110 (e.g., when power from other sources in unavailable) and/or external power sources such as power source 150.

Power source 150 may be a utility company or other type of power supply system. The power provided by power source 150 may be provided at voltage levels incompatible with the operation of data processing system 100. To facilitate use of the power provided by power source 150, adapter 140 may be used. Adapter may be a hardware device that converts power provided by power source 150 into a type usable by data processing system 100.

For example, adapter 140 may convert alternating current to direct current at a prescribed voltage level usable to power hardware components 102 (e.g., if active) and/or charge battery 110 (e.g., if at least partially discharged).

To charge battery 110 using the power, data processing system 100 may include charger 112. Charger 112 may use the power provided by adapter 140 to charge battery 110.

Similarly, to power hardware components 102 (and/or other components not shown), data processing system 100 may include regulator 114. Regulator 114 may include power regulation circuitry that may use power provided by adapter 140 or battery 110 to power hardware components 102. Regulator 114 may convert the power provided by adapter 140 or battery 110 to power at prescribed voltage and/or current levels expected by hardware components 102 and/or other components.

Use of power by hardware components 102 to provide computer implemented services and charger 112 to charge battery 110 may generate heat. Hardware components 102 and/or other components of data processing system 100 may have limited thermal operating ranges. To manage the heat generated by these components, data processing system 100 may include thermal management components 104.

Thermal management components 104 may include, for example, fans, baffles, heatsinks, and/or other types of components that may extract heat from components of data processing system and dissipate the extracted heat in the ambient environment around data processing system 100. For example, thermal management components 104 may draw gasses from the ambient environment into data processing system 100, direct the gasses proximate to hardware components 102 to exchange heat with the hardware components 102 to heat the gasses, and exhaust the gasses out of data processing system 100.

However, the capacity of thermal management components 104 to dissipate heat from data processing system 100 may be limited. For example, thermal management components 104 may only be able to cool sufficient heat to retain the components of data processing system 100 within their thermal operating ranges when up to 13 watts of power are dissipated by data processing system 100 in its operation. Thus, power dissipation by charger or other components may limit the rate at which hardware components 102 may dissipate power. Consequently, the performance of the computer implemented services provided by data processing system 100 may be limited by thermal dissipation by charger 112.

In general, embodiments disclosed herein may provide methods, systems, and/or devices for managing power consumption by components of data processing system 100 that do not directly contribute to the quality of computer implemented services as perceived by user of data processing system 100. To manage the power consumption, data processing system 100 may actively manage the voltage level of power supplied to it. By managing the voltage level of the power supplied to data processing system 100, the efficiency of power usage of components of data processing system 100 may be improved. Consequently, a larger portion of the limited thermal dissipation capacity provided by thermal management components 104 may be used to dissipate heat generated by hardware components 102.

Accordingly, hardware components 102 may consume larger amounts of power thereby providing higher performance. The higher performance (e.g., faster clock rates) of hardware components 102 may improve the quality of the computer implemented services as perceived by user of data processing system 100.

For example, the computer implemented services may be provided more quickly thereby improving the perceived responsiveness and performance of data processing system as observed by the users of data processing system. Other perceived benefits in operation of data processing system 100 may be provided without departing from embodiments disclosed herein.

To provide the above noted functionality, data processing system 100 may include management controller 130 and power manager 132. Each of these components is discussed below.

Management controller 130 may manage the operation of adapter 140 and charger 112. To do so, management controller 130 may (i) monitor the power state of data processing system 100 (e.g., a static state where power consumption levels are steady, a dynamic state where power consumption levels may change dynamically, etc.), (ii) configure the operation of adapter 140 and charger 112 based on the power state and voltage level of battery 110, and (iii) used the configured adapter and configured charger to charge battery 110 while battery 110 is at least partially discharged. By doing so, charger 112 may dissipate less power while charging battery 110, thereby conserving the limited ability of thermal management components 104 to dissipate heat generated by hardware components 102.

To configure operation of adapter 140 and charger 112, management controller 130 may identify voltage levels for the power supplied by each of these components. The respective voltage levels may be selected based on the voltage level of battery 110, the power consumption rate of data processing system 100, and the power state of data processing system 100. While data processing system 100 is in a static power state (e.g., such as while powered of, while hibernating, or other operating condition in which power consumption by hardware components 102 is expected to remain stable), management controller 130 may configure adapter 140 and charger 112 to provide power at a voltage level of battery 110. In such a scenario, charger 112 may be bypassed and the power provided by adapter 140 may flow directly to battery 110.

In contrast, while data processing system is in a dynamic power state, management controller 130 may configure adapter 140 to provide power at a voltage level that is higher than the voltage level of battery 110, and may configure charger 112 to provide power to battery 110 at the voltage level of battery 110.

For example, a scaling margin may be added to the voltage level of the battery to address potential transient power loads exhibited by hardware components 102 and/or other components of data processing system 100. Adapter 140 may not be able to respond to these changes in transient load with sufficient speed to prevent the transient load from drawing the voltage level of the power supplied by adapter 140 down to below desired levels (i.e., that of battery 110) if adapter 140 is configured to provide power at the desired voltage level. The scaling margin may ensure that even if drawn down, the power supplied by adapter 140 will have a voltage level sufficient to (i) prevent brownouts to components of data processing system 100 (e.g., regulator 114 may require at least the desired voltage level to continue to provide power to hardware components 102) and (ii) prevent hardware components 102 from taking action such as throttling processors to reduce power consumption to reduce the impact of brownouts.

The scaling margin may scale based on the amount of power drawn by data processing system 100, a maximum peak power of battery 110 at the current relative state of charge of the battery, and the peak power capability of adapter 140. For example, a voltage of two volts scaled based on a ratio of (i) the system power consumption to (ii) a sum of the maximum peak power of the battery and the peak power capability of the adapter. Thus, as the system power consumption is reduced the scaling margin may also reduce.

Management controller 130 may periodically identify the state of the system and update the configurations of adapter 140 and charger 112 as the conditions change. The period may be, for example, one every second, once every tenth of a second, or other time intervals.

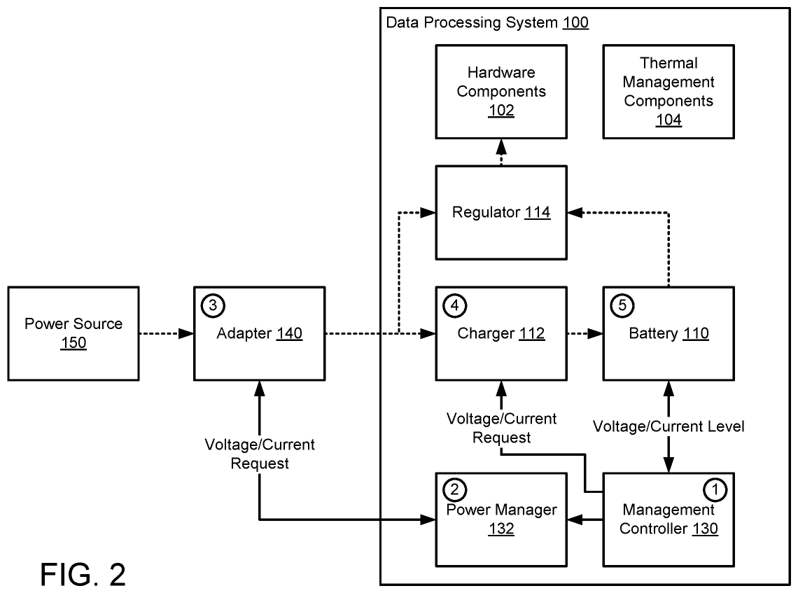

Refer to FIG. 2 for additional details regarding configuration of adapter 140 and charger 112 by management controller 130.

Power manager 132 may manage the configuration of adapter 140. To do so, power manager 132 may (i) obtain instructions from management controller 130, and (ii) communicate with adapter 140 to modify the configuration of adapter 140 over time. Power manager 132 may do so by, for example, sending commands to adapter 140 via a wiring harness that carries power to data processing system 100.

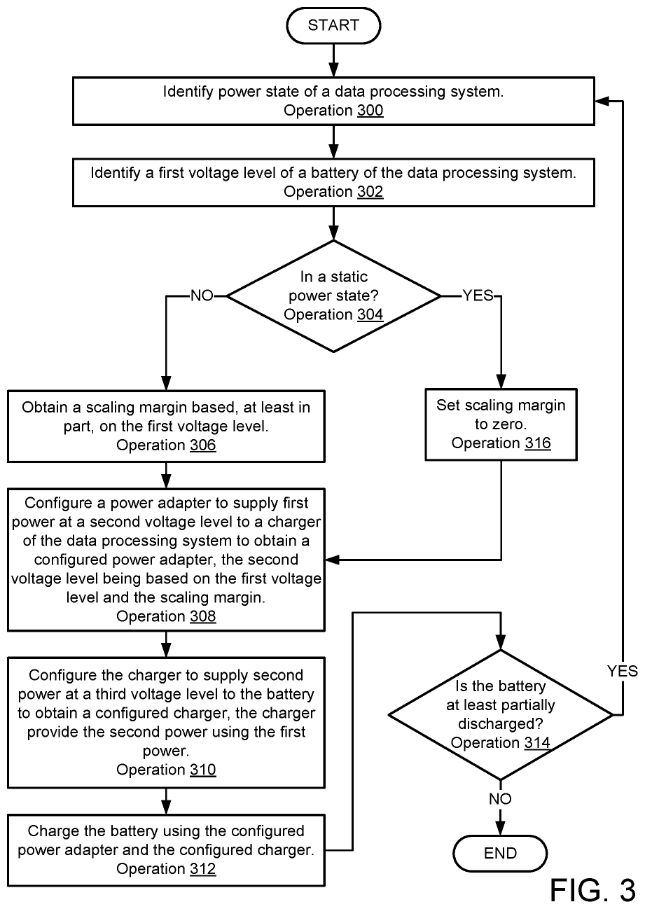

When providing their functionality, any of (and/or components thereof) management controller 130, power manager 132, adapter 140, charger 112, battery 110, regulator 114, hardware components 102 and thermal management components 104 may perform all, or a portion, of the method illustrated in FIG. 3.

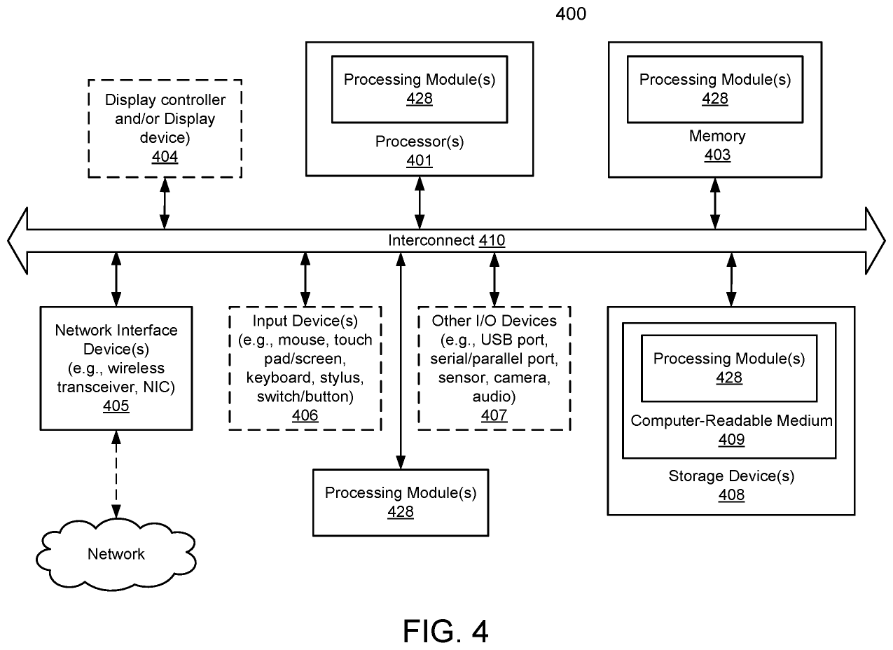

Data processing system 100 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Adapter 140 (also referred to as “power adapter”) may be implemented with a programmable power supply. Adapter 140 may include a programmable component that may implement a feedback control system for managing the voltage of power provided by adapter 140. The programmable component may implement an algorithm that may have a loop response that is slower than the rate at which hardware components 102 may change their power load. Consequently, the changes in power load exhibited by hardware components 102 may draw down the voltage level of the power provided by adapter 140 because the loop response to the load changes may be too slow.

Charger 112 may be implemented with circuitry adapted to provide power to battery 110. Charger 112 may be implemented with, for example, a boost-buck adapter that may boost the voltage level of input power when the voltage level falls below a configurable level (e.g., the voltage level of battery 110 to cause it to charge), and may buck the voltage level of input power down when the voltage level exceeds the configurable level. Boosting the voltage level may be less efficient than bucking the voltage level. To improve the efficiency of charger 112, management controller 130 may configure adapter 140 to ensure that the power provided by adapter 140 has a voltage level that is equal to or greater than the voltage level of battery 110, even while transient loads are exhibited by hardware components 102 through use of the scaling margin.

The power flows shown in FIG. 2 may be implemented using wiring harnesses, power buses, and/or other power distribution structures.

Any of the components shown in FIG. 1 may be operably connected to one another using and connectivity medium. For example, the components of data processing system 100 may be operably connected to each other via point to point links, data buses, and/or other communication mediums. Likewise, power source 150, adapter 140, and the components of data processing system 100 may be operably connected to one another via any number of wired and/or wireless links including, for example, the Internet.

While illustrated in FIG. 1 as including a limited number of specific components, a system in accordance with an embodiment may include fewer, additional, and/or different components than those components illustrated therein.

As discussed above, data processing system 100 may modify the manner in which adapter 140 and charger 112 operate over time to enhance the efficiency of operation of charger 112. Turning to FIG. 2, a flow diagram in accordance with an embodiment is shown. The flow diagram may illustrate operations performed by the components of data processing system 100 to manage the operation of adapter 140 and charger 112. In FIG. 2, activity of different components is highlighted using numbered blocks (e.g., 1, 2, 3, etc.) positioned over the component participate in the activity.

At block 1, management controller 130 may ascertain the charge state of battery 110. If battery is at least partially discharged, management controller 130 may, to charge battery 110: (i) identify the voltage level and/or current level of battery 110 by polling (e.g., periodically, in response to occurrences of events, and/or via other schemes) a battery management unit (not shown, may manage the cells of battery 110) integrated with the battery (and/or via other measurement hardware), (ii) identify the power state of data processing system 100, and (iii) configure adapter 140 (e.g., via power manager 132) and charger 112 to charge batter 110 based on the identified voltage/current level of battery 110 and the power state, which is further discussed in greater detail below.

If the power state of data processing system 100 is dynamic (e.g., hardware components 102 may exhibit transient loads), then data processing system may (i) identify the power consumption of data processing system 100, (ii) identify the battery maximum peak power at the current relative state of change, and (iii) identify the adapter peak power capability. Management controller 130 may then calculate a scaling margin based on the power consumption, battery maximum peak power, and adapter peak power capability. For example, the system power consumption may be divided by the sum of the battery maximum peak power and the adapter peak power capability to obtain a ratio. The ratio may then be used to scale a predetermined quantity, such as two volts, to obtain the scaling margin (e.g., between 0 and 2 volts).

Management controller 130 may then decide levels of voltage for power that adapter 140 and charger 112 are to provide. If the power state of data processing system 100 is dynamic, then management controller 130 may decide that adapter 140 is to output power at a voltage of the battery enhanced by the scaling margin (e.g., battery voltage+scaling margin) and charger 112 is to output power at the voltage level of battery 110. In contrast, if the power state of data processing system is static, then management controller 130 may decide that adapter is to output power at the voltage level of battery 110, and charger 112 is to enter a bypass mode where it just passes through the power provided to it without modification.

Management controller 130 may set the operation of power manager 132 and charger 112 based on these decided voltage levels. For example, management controller 130 may send requests (e.g., voltage level requests) or other communications to configure power manager 132 and charger 112, accordingly.

At block 2, power manager 132 may configure itself based on the voltage level request from management controller 130. Based on its new configuration, power manager 132 may send a similar voltage request to adapter 140 to update its operation accordingly.

At block 3, adapter 140 may obtain the voltage request and configures itself to (i) obtain power from power source 150 and (ii) provide power at the voltage level requested by power manager 132. Consequently, adapter 140 may provide power at a voltage level of battery 110 (e.g., if data processing system 100 is in a static power state) or higher than battery 110 (e.g., if data processing system 100 is in a dynamic power state). Consequently, the power provided by adapter 140 may be used by regulator 114 to power hardware components 102, and to power charger 112.

At block 4, charger 112 may obtain the voltage request and configure itself to (i) obtain power from adapter 140 and (ii) provide power to battery 110. To do so, charger 112 may either actively modify the voltage level of the provided power and pass the modified voltage level power to battery 110, or pass through the power directly to battery 110, depending on the instructions obtained from management controller 130 in the voltage level request.

At block 5, battery 110 may charge using the power supplied by charger 112.

Thus, via the flows shown in FIG. 2, a data processing system in accordance with an embodiment may charge battery 110 while limiting the impact on the operation of other components such as hardware components 102.

As discussed above, the components of FIG. 1 may perform various methods to manage the impact of battery charging on the operation of data processing systems. FIG. 3 illustrates a method that may be performed by the components of the system of FIG. 1. In the diagram discussed below and shown in FIGS. 3, any of the operations may be repeated, performed in different orders, and/or performed in parallel with or in a partially overlapping in time manner with other operations.

Turning to FIG. 3, a flow diagram illustrating a method for managing an endpoint device in accordance with an embodiment is shown. The method may be performed by any of data processing system 100, adapter 140, power source 150, and/or other components of the system (or components thereof) shown in FIG. 1.

Prior to operation 300, a management controller of a data processing system may identify that (i) a battery of the data processing system is at least partially discharged and (ii) an external source of power is available to charge the battery. The management controller may monitor the charge level of the battery over time, and may monitor to ascertain when a power adapter is operably connected to a charging port of the data processing system.

At operation 300, a power state of the data processing system is identified. The management controller may monitor the power state of the data processing system over time. The management controller may monitor the power state of the data processing systems by (i) actively monitoring for consumption of power by components of the data processing system, and/or (ii) receiving information regarding the power state of the data processing system from other entities (e.g., such as an operating system which may control the power state of the data processing system, a hardware management entity, and/or another type of entity).

At operation 302, a first voltage level of a battery of the data processing system is identified. The voltage level may be identified by (i) reading the voltage level (e.g., by requesting the voltage level from a battery manger, by activating measurement circuitry, etc.), (ii) by reading data reflecting the voltage level from storage, and/or via other methods.

At operation 304, a determination is made regarding whether the power state of the data processing system is a static power state. If the power state is a static power state, then the method may proceed to operation 316. Otherwise, the method may proceed to operation 306. Proceeding to either operation 306 or operation 316 may cause the management controller to configure a power adapter and charger differently. Each operations 306 and 316 are discussed below, before moving onto the discussion of operation 308.

At operation 306, a scaling margin is obtained. The scaling margin may be based on the first voltage of the battery. The scaling margin may also be based, as discussed with respect to FIG. 2, on the system power consumption, the ability of the power adapter to supply power, and the ability of the battery to supply power. The scaling margin may be, for example, a value between 0 and 2 volts, that increases as the ratio of the system power consumption to the sum of the power supply capabilities of the battery and power adapter.

The power adapter capabilities may be known. For example, the power adapter capabilities may be specified by a manufacturer, and may be pre-stored in the management controller.

The battery capabilities may be known. For example, the battery capabilities may be specified by a manufacturer, and may be pre-stored in the management controller.

The capabilities of the power adapter and/or the battery may depend on conditions of the respective conditions of the power adapter and battery. The management controller may monitor these conditions to allow for the capabilities of the power adapter and/or the battery to be ascertained. For example, the charge level of the battery may impact the ability of the battery to supply power.

The scaling margin may be set so that transient loads exhibited by components of the data processing system may be unlikely to cause brown outs to occur, to cause components to throttle their operation, and/or to cause the charger to enter a boost mode (e.g., may stay in buck mode).

Turning to operation 316, in contrast to operation 306 which may be performed while dynamic loads may be exhibited by other components of the data processing system, the scaling margin may be set to zero in operation 316 because dynamic loads are unlikely to occur while the data processing system is in the static power state. If the scaling margin is set to zero, then, as will be discussed below with respect to operation 310, the charger may enter a bypass mode to pass through power from the power adapter to the battery directly.

At operation 308, the power adapter is configured to supply first power at a second voltage level to the charger to obtain a configured power adapter. The second voltage level may be based on the first voltage level and the scaling margin. For example, the second voltage level may be the sum of the first voltage level and the scaling margin.

The power adapter may be configured by configuring a power manager to manage the power adapter based on the second voltage level. The power manager may update operation of the power adapter accordingly. For example, the power manager may pass information, instructions, etc. to the power adapter.

Thus, if the power state of the data processing system is static, the power adapter may provide power at the voltage level of the battery (or a voltage level slightly higher than that of battery 110 to ensure charging, for purposes of discussion through it, it should be appreciated that for charging purposes the voltage level of the battery means about that voltage level of the battery but sufficiently higher to ensure charging, such as 150 millivolts higher for example). For example, while the data processing system is in the static power state, adapter 140 may be configured to output a voltage level of approximately 150 millivolts greater than the voltage of battery 110. It will be appreciated that this margin may be different than 150 millivolts but set to efficiently charge battery 110 through minimizing the margin.

If the power state of the data processing system is not static, then the power adapter may provide power at a voltage level higher than the battery voltage level by the scaling margin.

At operation 310, the charger is configured to supply second power at a third voltage level to the battery to obtain a configured charger. The charger may provide the second power using the first power. The third voltage level may be the voltage level required to charge the battery.

If the voltage level of the first power is the same as the battery, then the charger may enter a bypass mode and pass the first power through to the battery. In contrast, the charger may modify the first power prior to passing it through to the battery to conform it to the voltage level of the battery if the first power is at a different voltage level from the battery.

The charger may be configured by sending instructions and/or other information to the charger. The instructions may specify the third voltage level, or to enter the bypass mode of operation.

At operation 312, the battery is charged using the configured power adapter and the configured charger. The charging may increase the charge level of the battery. The charging may continue for a duration of time with the configured power adapter and configured charger. For example, because the state of the data processing may change over time, the charging under these conditions may only occur for a duration of time (e.g., one second, one tenth of one second, etc.). Consequently, the battery may still only be partially charged while the charging of operation 312 has been performed.

At operation 314, a determination is made regarding whether the battery is still at least partially discharged. The determination may be made, for example, by performing a measurement regarding the charge level of the battery.

If the battery is still at least partially discharged, then the method may return to operation 300. Otherwise, the method may end following operation 314.

Using the method illustrated in FIG. 3, embodiments disclosed herein may facilitate charging of batteries of data processing systems while limiting the impact of the charging on other components. By dynamically adjusting the configuration of the power adapter and charger to adjust to changing conditions, the efficiency of charging may be improved when compared to systems where static power adapters are used. Further, by increasing the voltage level of supplied power above the voltage level of the battery by a scaling margin, the likelihood of brownouts and inefficient charging may be reduced.

Any of the components illustrated in FIGS. 1-2 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing charging of a battery of a data processing system, the method comprising:
while the battery is at least partially discharged:
identifying a first voltage level of the battery;
obtaining a scaling margin based, at least in part, on the first voltage level and a power state of the data processing system;
configuring a power adapter to supply first power at a second voltage level to a charger of the data processing system to obtain a configured power adapter, the second voltage level being based on the first voltage level and the scaling margin;
configuring the charger to supply second power at a third voltage level to the battery to obtain a configured charger, the charger providing the second power using the first power; and
charging the battery using the configured power adapter and the configured charger.

2. The method of claim 1, wherein the configuring of the power adapter and the configuring of the charger is performed repeatedly at predefined time intervals to update the second voltage level and the third voltage level over time while the battery is at least partially discharged.

3. The method of claim 2, wherein the power adapter has a loop response for updating the second voltage that is slower than the predefined time intervals.

4. The method of claim 3, wherein the data processing system comprises at least one hardware component that places transient loads on the adapter that exceed a capacity of the loop response to maintain the second voltage.

5. The method of claim 4, wherein obtaining the scaling margin comprises:
in a first instance of the power state being a dynamic power consumption state:
identifying power consumption by the data processing system; and
identifying the scaling margin based, at least in part, on the power consumption that is likely to retain the charger in buck mode rather than boost mode.

6. The method of claim 5, wherein the scaling margin is further based on a battery maximum peak power at a current relative state of charge of the battery, and a peak power capability of the power adapter.

7. The method of claim 5, wherein obtaining the scaling margin comprises:
in a second instance of the power state being a static power consumption state:
setting the scaling margin to zero.

8. A non-transitory machine-readable medium having instructions stored therein, which when executed by at least one processor, cause a system to perform operations for managing charging of a battery of a data processing system, the operations comprising:
while the battery is at least partially discharged:
identifying a first voltage level of the battery;
obtaining a scaling margin based, at least in part, on the first voltage level and a power state of the data processing system;
configuring a power adapter to supply first power at a second voltage level to a charger of the data processing system to obtain a configured power adapter, the second voltage level being based on the first voltage level and the scaling margin;
configuring the charger to supply second power at a third voltage level to the battery to obtain a configured charger, the charger providing the second power using the first power; and
charging the battery using the configured power adapter and the configured charger.

9. The non-transitory machine-readable medium of claim 8, wherein the configuring of the power adapter and the configuring of the charger is performed repeatedly at predefined time intervals to update the second voltage level and the third voltage level over time while the battery is at least partially discharged.

10. The non-transitory machine-readable medium of claim 9, wherein the power adapter has a loop response for updating the second voltage that is slower than the predefined time intervals.

11. The non-transitory machine-readable medium of claim 10, wherein the data processing system comprises at least one hardware component that places transient loads on the adapter that exceed a capacity of the loop response to maintain the second voltage.

12. The non-transitory machine-readable medium of claim 11, wherein obtaining the scaling margin comprises:
in a first instance of the power state being a dynamic power consumption state:
identifying power consumption by the data processing system; and
identifying the scaling margin based, at least in part, on the power consumption that is likely to retain the charger in buck mode rather than boost mode.

13. The non-transitory machine-readable medium of claim 12, wherein the scaling margin is further based on a battery maximum peak power at a current relative state of charge of the battery, and a peak power capability of the power adapter.

14. The non-transitory machine-readable medium of claim 12, wherein obtaining the scaling margin comprises:
in a second instance of the power state being a static power consumption state:
setting the scaling margin to zero.

15. A data processing system, comprising:
hardware components;
a battery adapted to, at least in part, power the hardware components;
a management controller comprising:
at least one processor; and
a memory that is coupled to the processor and stores instructions, which when executed by the processor, cause the data processing system to perform operations for managing charging of the battery, the operations comprising:
while the battery is at least partially discharged:
identifying a first voltage level of the battery;
obtaining a scaling margin based, at least in part, on the first voltage level and a power state of the data processing system;
configuring a power adapter to supply first power at a second voltage level to a charger of the data processing system to obtain a configured power adapter, the second voltage level being based on the first voltage level and the scaling margin;
configuring the charger to supply second power at a third voltage level to the battery to obtain a configured charger, the charger providing the second power using the first power; and
charging the battery using the configured power adapter and the configured charger.

16. The data processing system of claim 15, wherein the configuring of the power adapter and the configuring of the charger is performed repeatedly at predefined time intervals to update the second voltage level and the third voltage level over time while the battery is at least partially discharged.

17. The data processing system of claim 16, wherein the power adapter has a loop response for updating the second voltage that is slower than the predefined time intervals.

18. The data processing system of claim 17, wherein the data processing system comprises at least one hardware component that places transient loads on the adapter that exceed a capacity of the loop response to maintain the second voltage.

19. The data processing system of claim 18, wherein obtaining the scaling margin comprises:
in a first instance of the power state being a dynamic power consumption state:
identifying power consumption by the data processing system; and
identifying the scaling margin based, at least in part, on the power consumption that is likely to retain the charger in buck mode rather than boost mode.

20. The data processing system of claim 19, wherein the scaling margin is further based on a battery maximum peak power at a current relative state of charge of the battery, and a peak power capability of the power adapter.
